(19) United States
(12) Patent Application Publication
(10) Pub. No.: US 2008/0220154 A1
(43) Pub. Date: Sep. 11, 2008

(54) METHOD OF FORMING FLUID FLOW FIELD PLATES FOR ELECTROCHEMICAL DEVICES

(76) Inventor: Emerson R. Gallagher, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/043,376

(22) Filed: Mar. 6, 2008

Related U.S. Application Data
(60) Provisional application No. 60/893,319, filed on Mar. 6, 2007.

(51) Int. Cl. B05D 1/00

(52) U.S. Cl. 427/115

(57) ABSTRACT

A method of making graphite articles for electrochemical fuel cells, such as fluid flow field plates, by partially impregnating a porous, self-supporting expanded graphite sheet with a first binder comprising a first liquid resin to form a partially impregnated graphite sheet; mechanically deforming at least one surface of the impregnated graphite sheet to form an intermediate fluid flow field plate; impregnating the mechanically deformed intermediate fluid flow field plate with a second binder comprising a second liquid resin to form an impregnated fluid flow field plate; and curing at least the second resin to form a substantially fluid impermeable fluid flow field plate.

### CROSS-REFERENCE TO RELATED APPLICATION

This application claims the benefit under 35 U.S.C. § 119(e) of U.S. Provisional Patent Application No. 60/893,319 filed Mar. 6, 2007, which provisional application is incorporated herein by reference in its entirety.

### BACKGROUND

1. Technical Field

The present invention is generally directed to methods of making fluid flow field plates for electrochemical devices, in particular, fuel cells.

2. Description of the Related Art

Electrochemical fuel cells convert fuel and oxidant into electricity. Solid polymer electrochemical fuel cells generally employ a membrane electrode assembly (MEA) that includes an ion exchange membrane or solid polymer electrolyte disposed between two electrodes. The membrane is ion conductive (typically proton conductive), and acts both as a barrier for isolating the reactant streams from each other and as an electrical insulator between the two electrodes. Each electrode typically comprises a porous, electrically conductive substrate, such as carbon fiber paper or carbon cloth, which provides structural support to the membrane and serves as a fluid diffusion layer, with an electrocatalyst disposed on a surface of the substrate. The electrocatalyst is typically a precious metal composition (e.g., platinum metal black or an alloy thereof) and may be provided on a suitable support (e.g., fine platinum particles supported on a carbon black support). The location of the electrocatalyst generally defines the electrochemically active area. In operation, the electrodes are electrically coupled for conducting electrons between the electrodes through an external circuit. A number of membrane electrode assemblies are usually electrically coupled in series to form a fuel cell stack having a desired power output.

The MEA is typically interposed between two electrically conductive and substantially fluid impermeable bipolar flow field plates or separator plates. These bipolar flow field plates act as current collectors, provide support for the electrodes, and provide flow fields for directing reactants, such as fuel and oxidant, to the MEA and for removing excess reactants and products that are formed during operation, such as product water, while fluidly isolating the fuel, oxidant, and coolant. In some cases, the bipolar flow field plate is formed by joining two flow field plates together; namely, an anode flow field plate and a cathode flow field plate, so that an anode flow field is formed on one surface of the bipolar flow field plate, a cathode flow field is formed on an opposing surface of the bipolar flow field plate, and a coolant flow field is formed between the anode flow field plate and the cathode flow field plate. In other cases, the bipolar flow field plate may be a single plate that has an anode flow field on one surface and a cathode flow field on an opposing surface. Typically, flow field channels are formed on at least one surface of the flow field plate by methods such as molding, machining and embossing, depending on the nature of the material. FIGS. 1-4 (prior art) collectively illustrate a typical design of a conventional MEA 5, with electrodes 1, 3 sandwiching an ion-exchange membrane 2 therebetween; an electrochemical cell 10 comprising an MEA 5 between fluid flow field plates 11, 12; a stack 50 of such cells that is compressed between endplates 17, 18; and manifolds 30 for delivering and removing reactants and products to and from the fuel cells during operation.

Fluid flow field plates 11, 12 in FIG. 2 are generally formed from a suitable electrically conductive material, for example, non-metals (such as carbon and graphite), metals (such as surface-treated stainless steels and titanium), and electrically conductive polymeric composite materials. Materials that have a high surface roughness or surface irregularities, such as fibrous materials or materials that contain mostly fibrous components, are typically not suitable as fluid flow field plates for fuel cell applications because they may have an undesirable affect on water management during fuel cell operation, for example, creating fluid flow anomalies and/or not permitting sufficient fluid flow through the fuel cell during operation. Current metallic materials are also undesirable because they corrode readily in the acidic fuel cell environment, particularly under dynamic fuel cell operating conditions where the fuel cell is subjected to extreme potentials. Thus, more recent fuel cells typically employ carbon- and graphite-based materials for fluid flow field plates.

Conventional methods of making carbonaceous and graphitic fluid flow field plates, such as those described in U.S. Pat. No. 6,764,624, include the steps of producing dry granules of a composition for a fuel cell separator mainly containing a conductive material, a binder (such as a thermosetting resin), and an additive by mixing raw materials of the composition, granulating the mixture, drying the granules; packing the dry granules in a mold, and hot press molding the dry granules. Specific examples of the conductive materials may include carbon black, ketchen black, acetylene black, carbon whiskers, graphite, metal fibers, and powders of titanium oxide, ruthenium oxide, and the like. In particular, graphite is preferably used as the conductive material. Graphite may be natural graphite or artificial graphite, and may be of any shape such as flake, massive, needle or spherical shape. The average particle size of graphite is preferably in a range of 10 to 80 microns, and more preferably, in a range of 20 to 60 microns. The content of the binder may be in the range of 5 to 30 parts by mass, and preferably 10 to 25 parts by mass, on the basis of 100 parts by mass of the conductive material. Typically, when the content of the binder is more than 30 parts by mass, the content of the conductive material becomes corresponding small, to lower the conductivity of the final separator.

However, it is desirable to manufacture plates with a higher resin content to improve fluid impermeability and formability (for forming complex shapes with high aspect ratios), but without significantly decreasing thermal and electrical conductivity. Thus, in some methods, expanded natural graphite that is compressed or calendered into self-supporting graphite sheets, such as that described in U.S. Pat. No. 3,404,061, is used for fluid flowfield plates. Such self-supporting graphite sheets can be formed without the use of any resin or binding material, believed to be due to mechanical interlocking, or cohesion, which is achieved between the voluminously expanded graphite particles. After compression or calendering, these self-supporting graphite sheets exhibit a high degree of anisotropy with respect to electrical and thermal conductivity. Such conductivity is comparable to the natural graphite starting material due to orientation of the expanded graphite particles substantially parallel to the opposed faces of the sheet, which orientation results from very high compression (such as achieved with roll pressing).

Sheet materials thus produced have excellent flexibility, good strength and a very high degree of orientation, and are self-supporting, even in the absence of a binder or resin. These porous, self-supporting graphite sheets can further be treated with a resin, and the absorbed resin, after curing, eliminates through-plane permeability while increasing handling strength (i.e., stiffness) of the graphite sheet, as well as fixing the morphology of the sheet. Suitable resin content is preferably at least about 5% by weight of the graphite sheet, and more preferably about 10 to 45% by weight of the graphite sheet, and suitably up to about 60% by weight of the graphite sheet. Without being bound by theory, fluid flow field plates made using such resin-impregnated, expanded graphite sheets have higher resin contents than molded fluid flow field plates made using graphite particles cured together with a binder, such as that described in U.S. Pat. No. 6,764,624, because the expanded graphite forms a continuous graphitic phase (due to mechanical interlocking of the expanded graphite) prior to impregnation with resin. Even after impregnating with a higher amount of resin, the continuous graphitic phase allows sufficient electrical and thermal conductivity, while also providing improved fluid impermeability, mechanical strength and formability in comparison to molded fluid flow field plates made using graphite particles.

One method for continuously manufacturing a fluid flow field plate using expanded natural graphite is described in U.S. Pat. No. 6,432,336. This method comprises continuously compressing a stream of exfoliated graphite particles into a continuous coherent self-supporting mat of flexible graphite; continuously contacting the flexible graphite mat with liquid resin and impregnating the mat with liquid resin; and continuously calendering the flexible graphite mat to increase the density thereof to form a continuous flexible graphite sheet. The calendered flexible graphite sheet is mechanically deformed at its surface by embossing, die stamping or the like, and thereafter heated in an oven to cure the resin, to continuously provide a flexible graphite sheet of repeated surface altered patterns, which can be cut to provide flexible graphite components such as a fuel cell fluid flow plate. This method, in which resin-impregnation occurs prior to mechanical deformation, is hereinafter referred to as “pre-impregnation”.

However, because resin-impregnation occurs prior to mechanical deformation in pre-impregnation processes, compression of the plate may not be consistent throughout. For example, for some of the more complex shapes, the thinner portions of the plate may have a lower porosity than the raised portions of the plates because compression in the raised portions is less than that of the thinner portions. As a result, the raised portions on the surface of the plates, such as the flow field landings, may be prone to leaks due to fluid permeability. Furthermore, the dimensions and aspect ratios of the features may be limited in order to meet impermeability requirements after mechanical deformation.

Alternatively, the porous, self-supporting mat of flexible graphite may be mechanically deformed after compression or calendaring to form a pattern thereon, and then impregnated with a suitable resin (hereinafter referred to as “post-impregnation”), such as that described in U.S. Pat. Nos. 6,534,115 and 6,800,328. However, post-impregnation processes are not desirable for all applications as it is difficult to impregnate the resin into the pores of the mechanically deformed graphite sheet because the pores are compressed and trapped within the material. Thus, post-impregnation typically requires very low viscosity resins, thereby limiting the available resin options to reduce cost and/or impart the desired mechanical properties to the fluid flow field plate, such as strength, temperature resistance, and/or chemical resistance. Additionally, more aggressive impregnation conditions may be required to ensure sufficient impregnation of the resin into the pores of the embossed graphite sheet, which may not be desirable for large-scale manufacturing and cost considerations.

As a result, there remains a need for methods of making fluid flow field plates of expanded graphite having high aspect ratio features, while still being substantially fluid impermeable, as well as having sufficient electrical and thermal conductivity. The present invention addresses this issue and provides further related advantages.

### BRIEF SUMMARY

In one embodiment, a method is provided for making a fluid flow field plate for fuel cells, the method comprising: partially impregnating a porous, self-supporting graphite sheet with a first binder comprising a first liquid resin to form a partially impregnated graphite sheet; mechanically deforming at least one surface of the partially impregnated graphite sheet to form an intermediate fluid flow field plate; impregnating the intermediate fluid flow field plate with a second binder comprising a second liquid resin to form an impregnated fluid flowfield plate; and curing at least the second liquid resin to form a substantially fluid impermeable fluid flow field plate.

In some embodiments, the first and second binders solely comprise the first liquid resin and second liquid resin, respectively. In another embodiment, the first and second binders comprise the same or different solvents and the first liquid resin and second liquid resin, respectively, the solvent serving to decrease the viscosity of the first and second liquid resins and/or to enhance impregnation therewith. The first and second resins may be the same or different, and independently may be a phenolic-, epoxy-, or acrylic-based resin, or combinations thereof.

In further embodiments, the method comprises heating before, during and/or after mechanically deforming the partially impregnated graphite sheet. Such mechanical deforming can be achieved by any of a variety of techniques, including molding, stamping, calendering, machining, and embossing.

These and other aspects of the invention will be evident upon reference to the attached figures and following detailed description.

### BRIEF DESCRIPTION OF THE SEVERAL VIEWS OF THE DRAWINGS

FIG. 1 is an exploded isometric view of a membrane electrode assembly according to the prior art.

FIG. 2 is an exploded isometric view of an electrochemical cell according to the prior art.

FIG. 3 is an exploded isometric view of an electrochemical cell stack according to the prior art.

FIG. 4 is an isometric view of an electrochemical cell stack according to the prior art.

FIG. 5 is flow chart of a representative method of the present invention.

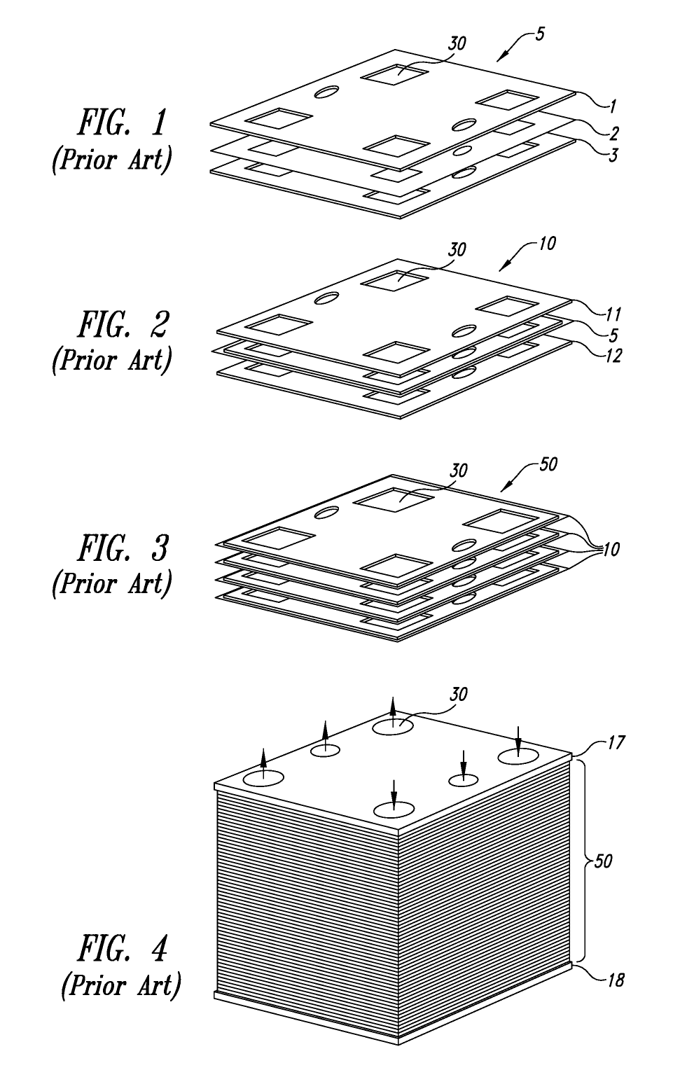

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electrochemical systems and/or cells and/or fabrication of such cells such as, but not limited to, membrane electrode assemblies, manifolds, coolant loops, various valves, and external circuits, have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As noted above, the present invention is related to methods of making fluid impermeable articles from porous graphitic materials, such as fluid flow field plates used in fuel cells. More specifically, the method comprises partially impregnating a porous, self-supporting graphite sheet with a first binder comprising a first liquid resin to form a partially impregnated graphite sheet; mechanically deforming at least one surface of the partially impregnated graphite sheet to form an intermediate fluid flow field plate; impregnating the intermediate fluid flow field plate with a second binder comprising a second liquid resin to form an impregnated fluid flow field plate; and curing at least the second liquid resin to form a substantially fluid impermeable fluid flow field plate.

Reference throughout this specification to “substantially fluid impermeable” should not be understood necessarily as hermetically sealed. In this regard, generally, a fluid flow field plate is “substantially fluid impermeable” if, in operation, intermixing of the various fluids flowing across opposing sides of the plate is sufficiently restricted that fuel cell performance, durability and safety are not unduly compromised.

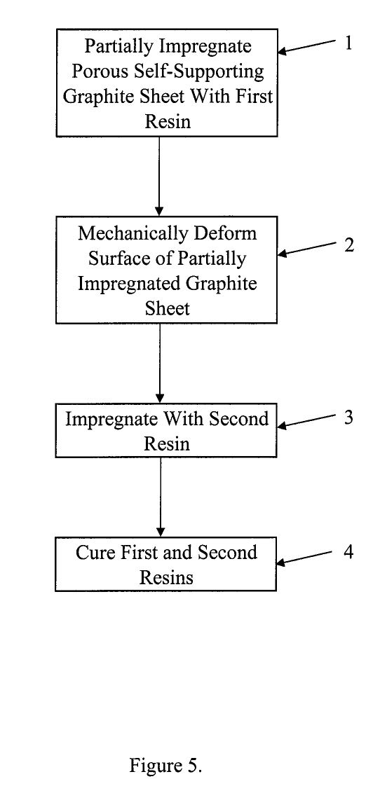

With reference to FIG. 5, at block 1, a porous, self-supporting graphite sheet is partially impregnated (or filled) with a first binder (the impregnant) comprising a first liquid resin to form a partially impregnated graphite sheet. In this context, “porous, self-supporting graphite sheet” means sheet materials comprised of a compressed mass of expanded graphite flakes (which may be natural and/or synthetic) in the absence of a resin, such as that described in U.S. Pat. No. 3,404,061, composites thereof, such as the composite described in U.S. Pat. No. 5,885,728, and laminates that include one or more layers comprising expanded graphite sheets. Prior to any resin impregnation, such porous, self-supporting graphite sheets maintain a compression set and typically contain a porosity or void volume of about 30 to 90%, a density ranging from about 0.5 to 2 gram/cc, and a thickness ranging from about 5 to 15 mm. For example, the porous, self-supporting graphite sheet may be the TG 440 and TG 504 materials, which are supplied by Advanced Energy Technology, Inc. (Parma, Ohio). Partial impregnation of the porous, self-supporting graphite sheet should be controlled so that at least a portion of the porosity of the porous, self-supporting graphite sheet remains after resin impregnation. The resin content of the partially impregnated graphite sheet generally ranges from about 5 to 60 wt %, and typically from about 30 to 40 wt %.

At block 2, the partially impregnated graphite sheet is mechanically deformed to form a pattern on at least one planar surface of the sheet, for example, flow field channels and/or manifolds, thereby forming an intermediate fluid flow field plate. Methods of mechanical deformation include molding, stamping, calendering, machining, and embossing, such as the embossing method described in U.S. Pat. No. 6,818,165. After mechanical deformation, the residual porosity or void volume of the intermediate fluid flow field plate may range from 1 to 35%. In some embodiments, the partially impregnated graphite sheet is mechanically deformed under reduced pressure, such as that described in U.S. Patent Application Publication No. 2003/0051797, because the partially impregnated graphite sheet retains at least some residual porosity. Such residual porosity will also allow more complex patterns with a wider range of dimensions to be formed because more of the bulk material may flow to a certain extent during embossing. Optionally, the partially impregnated graphite sheet may be heated above ambient temperature during mechanical deformation to enhance material flow, thereby improving porosity consistency and strength throughout the plate and its features. In some embodiments, the partially impregnated graphite sheet may be mechanically deformed in two or more steps. For example, the partially impregnated graphite sheet may first be calendered and then embossed with flow field channels. Furthermore, in some embodiments, the first resin may be optionally cured or partially cured after mechanical deformation (described in further detail below).

At block 3, the intermediate fluid flow field plate is impregnated with a second binder containing a second liquid resin to form an impregnated fluid flow field plate. Subsequent impregnation of the second resin after embossing allows impregnation of at least a portion of the residual void volume. In some embodiments, the second resin content of the impregnated flow field plate ranges from about 1 to 30 wt %, and in further embodiments, from about 1 to 5 wt %. The second resin content should be such that the electrical, mechanical and chemical properties of the resulting fluid flow field plate is sufficient for fuel cell operation.

At block 4, the impregnated fluid flow field plate is heated to cure the second resin (and optionally the first resin, if not yet cured already), thereby forming a substantially fluid impermeable fluid flow field plate. Curing temperatures may range from about 80° C. to about 200° C., and curing times may range from about 15 minutes to about 120 minutes, depending on the type of resins used. One skilled in the art will appreciate that curing is necessary to stabilize the resin through cross-linking of the polymer in the resin, thus preventing the resin from washing out over time and improving stiffness and strength of the fluid flow field plate. Furthermore, other methods known in the art to cure resins, such as UV curing, may also be employed so long as the resin(s) is suitable for such curing methods. After curing, the in-plane thermal conductivity may range from about 50 W/mK to about 200 W/mK and the through-plane thermal conductivity may range from about 3 W/mK to about 60 W/mK, while the in-plane electrical conductivity may range from about 500 S/cm to about 2500 S/cm and the through-plane electrical conductivity may range from about 5 S/cm to about 60 S/cm. In addition, the density of the substantially fluid impermeable flow field plate may range from about 1.6 to 2.1 grams/cc and the thickness may range from about 0.003 to about 1.0 inch. Typically, the residual porosity of the plate after curing the first and second resins should be less than about 1%.

Any suitable resin for impregnating expanded graphite sheets for fuel cell fluid flow field plates may be used in the present method. In selecting suitable resins, the first and second resins should be able fill at least a portion of the pores of the porous, self-supporting graphite sheet during the resin impregnation steps to ensure cohesiveness of the final product. Preferably, the first and second resins are in liquid form during resin impregnation so that the resin can substantially impregnate the pores of the porous, self-supporting graphite sheet. After curing, the resins should enhance fluid resistance and impermeability properties to the sheet, improve handling strength, and be chemically stable (i.e., not oxidize, deteriorate, or wash out) over the lifetime of the fuel cell and at normal operating conditions.

The first and/or second resins may be, for example, a phenolic-, epoxy-, or acrylic-based resin, or combinations thereof. Additionally, or alternatively, the first and/or second resins may be a melamine-, polyamide-, polyamidimide-, or phenoxy-based resin. In some embodiments, the first and second resins are the same and in other embodiments, the first and second resins are different. For example, the first resin may be an epoxy-based resin and the second resin may be a methacrylate-based resin. In either case, the first and second resin may be cured together after impregnation of the second resin, individually cured after each impregnation, or partially curing the first resin after impregnation of the first resin and then curing the first resin with the second resin after impregnation of the second resin. In some embodiments, the viscosity of the second resin is lower than the viscosity of the first resin.

It is important that the fluid flow field plates are sufficiently resin-impregnated to be suitable for use in fuel cells. If impregnation is too low, the resulting flow field plate may be prone to leaks and/or decreased durability. However, if impregnation is too high (i.e., leading to excess resin on the surface of the plate), there may be a degradation or loss of desired structural and/or functional properties. Thus, impregnation of the first and second resins should be controlled so that a desired amount of impregnation occurs. For example, partial impregnation of the first resin should be such that a certain amount of residual porosity or void volume exists after partial impregnation so that mechanical deformation is improved (for example, wherein the void volume of the intermediate fluid flow field plate is equal to or less than about 20% or even 5%, or less than about 5% or even 3% of the total volume of the intermediate fluid flow field plate). Similarly, impregnation of the second resin should be such that the impregnated fluid flow field plate contains a desired amount of resin in at least a portion of the residual void volume to achieve the desired levels of impermeability and mechanical stability (that is, structural strength and hardness).

Methods of controlling the level of impregnation are not material to the present invention and persons skilled in the art can readily select suitable methods for a given application. For example, the binder may further comprise a solvent to dilute the resin to a predetermined ratio. The ratio should be such that upon saturation of the liquid resin into the porous expanded graphite sheet and removal of the solvent by vaporization (e.g., by air drying and/or heating, for example, before or during curing), the impregnated graphite sheet will contain the desired resin loading and desired residual volume. The solvent may be, for example, an alcohol, water, or combinations thereof, to decrease the viscosity of the liquid resin and/or to enhance impregnation of the liquid resin into the pores of the porous expanded graphite sheet. Alternatively, resin impregnation may be controlled by measuring the effective volume of the resin or the buoyancy of the plate, such as the methods described in U.S. Pat. Nos. 6,299,933 and 6,534,115, respectively. In some embodiments, a vacuum may be applied during impregnation of the first and/or second resins so that the resin can be drawn into the pores of the graphite sheet.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereof.

1. A method of making a fluid flow field plate for fuel cells, the method comprising:
partially impregnating a porous, self-supporting graphite sheet with a first binder comprising a first liquid resin to form a partially impregnated graphite sheet;
mechanically deforming at least one surface of the partially impregnated graphite sheet to form an intermediate fluid flow field plate;
impregnating the intermediate fluid flow field plate with a second binder comprising a second liquid resin to form an impregnated fluid flow field plate; and
curing at least the second liquid resin to form a substantially fluid impermeable fluid flow field plate.

2. The method of claim 1, wherein the porous, self-supporting graphite sheet comprises a compressed mass of expanded graphite.

3. The method of claim 1, wherein a first resin content of the impregnated graphite sheet is about 5 wt % to about 60 wt %.

4. The method of claim 1, wherein a first resin content of the impregnated graphite sheet is about 30 wt % to about 40 wt %.

5. The method of claim 1, wherein a void volume of the intermediate fluid flow field plate is equal to or less about 20% of the total volume thereof.

6. The method of claim 1, wherein the void volume of the intermediate fluid flow field plate is equal to or less than about 5% of the total volume thereof.

7. The method of claim 1, wherein the first and second resins are the same.

8. The method of claim 1, wherein the viscosity of the first liquid resin is less than the viscosity of the second liquid resin.

9. The method of claim 1, wherein at least one of the first and second resins is selected from the group consisting of phenolic-, epoxy-, and acrylic-based resins, and combinations thereof.

10. The method of claim 1, wherein at least one of the first and second resins is selected from the group consisting of melamine-, polyamide-, polyamidimide-, and phenoxy-based resins, and combinations thereof.

11. The method of claim 1, wherein the first liquid resin is an epoxy-based resin and the second liquid resin is an acrylic-based resin.

12. The method of claim 1, wherein the first binder further comprises a solvent, the method further comprising removing at least a portion of the solvent prior to mechanically deforming.

13. The method of claim 1, wherein mechanically deforming at least one surface of the partially impregnated graphite sheet comprises forming a pattern thereon.

14. The method of claim 13, wherein mechanically deforming at least one surface of the partially impregnated graphite sheet further comprises molding, stamping, calendering, machining, and embossing.

15. The method of claim 1, wherein mechanically deforming at least one surface of the partially impregnated graphite sheet comprises a first calendering step and a second embossing step to form a pattern thereon.

16. The method of claim 1, wherein mechanically deforming at least one surface of the partially impregnated graphite sheet further comprises heating the impregnated graphite sheet.

17. The method of claim 1, further comprising a first curing step to at least partially cure the first resin after mechanical deformation and prior to impregnating the intermediate fluid flow field plate with the second binder.

18. The method of claim 1, wherein curing at least the second resin further comprises curing the first resin.
